(19) United States
(12) Patent Application Publication
(10) Pub. No.: US 2014/0362622 A1
(43) Pub. Date: Dec. 11, 2014

(54) Controlling Operation of a Converter Having a Plurality of Semiconductor Switches for Converting High Power Electric Signals from DC to AC or from AC to DC

(71) Applicants: Hamed Nademi, Trondheim (NO); Lars Norum, Trondheim (NO)

(72) Inventors: Hamed Nademi, Trondheim (NO); Lars Norum, Trondheim (NO)

(21) Appl. No.: 14/296,158

(22) Filed: Jun. 4, 2014

(30) Foreign Application Priority Data
Jun. 5, 2013 (EP) EP 13170675.6

(51) Int. Cl. H02M 7/797

(52) U.S. Cl. CPC H02M 7/797
USPC 363/78

(57) ABSTRACT

A method for controlling operation of a power converter is provided. The method includes determining, in a rotating dq-reference frame, a direct current error signal and a quadrature current error signal, performing a first control procedure, and performing a second control procedure. The method also includes obtaining a direct voltage control signal by subtracting a signal resulting from the second control procedure from a signal resulting from first control procedure, and obtaining a quadrature voltage control signal by adding a signal resulting from the second control procedure to a signal resulting from the first control procedure. The method includes executing a transformation from the rotating dq-reference frame to a stationary abc-reference frame based on the obtained signals, and controlling switching states of the plurality of semiconductor switches based on the signals resulting from the executed transformation from the rotating dq-reference frame to the stationary abc-reference frame.

This application claims the benefit of EP 13170675.6, filed on Jun. 5, 2013, which is hereby incorporated by reference in its entirety.

### FIELD

The present embodiments generally relate to the technical field of converting high power electric signals from DC to AC or from AC to DC.

### BACKGROUND

For the purpose of the low-loss conversion of electric energy, a plurality of rectifier or inverter circuits are known. Such converter circuits are used in the higher power range to control the flow of energy between electrical machines and power systems (e.g., variable speed drives) or between different power systems (e.g., power couplings). High power converters may also be used for performing a reactive power compensation and voltage stabilization in power supply networks.

Modular multilevel converter (MMC) is a converter topology that has gained considerable attention in academia and industry in recent times. In this topology, additional advantages may be provided over other conventional voltage source converters. The modular structure, low device rating, and fault tolerant capacity are some of the key features of MMC. The MMC has already been introduced in the market for high voltage dc power transmission (HVDC). It is expected that MMC may also be used in dc to ac (dc-ac) power conversion (e.g., for ac drives).

Using rotating dq-reference frame theory, in a steady-state operation, all sinusoidal signals within a MMC are transformed into dc quantities and may be easily adjusted by proportional-integral (PI) controllers. However, conventional approaches for controlling the operation of a MMC are sensitive to load parameters, which may influence the dynamic response and the stability of the whole MMC system.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, control of operation of a high power converter including a plurality of semiconductor switches in a stable and reliable manner is provided.

According to a first aspect, a method for controlling operation of a DC-AC or AC-DC converter includes a plurality of semiconductor switches. The provided method includes determining, in a rotating dq-reference frame, a direct current error signal and a quadrature current error signal, performing a first control procedure with the direct current error signal and with the quadrature current error signal, and performing a second control procedure with the direct current error signal and with the quadrature current error signal. The method also includes obtaining a direct voltage control signal by subtracting the signal resulting from the second control procedure of the quadrature current error signal from the signal resulting from first control procedure of the direct current error signal, and obtaining a quadrature voltage control signal by adding the signal resulting from the second control procedure of the direct current error signal to the signal resulting from first control procedure of the quadrature current error signal. The method includes executing a transformation from the rotating dq-reference frame to a stationary abc-reference frame based on the obtained direct voltage control signal and the obtained quadrature voltage control signal (u_{q}), and controlling the switching states of the plurality of semiconductor switches based on the signals resulting from the executed transformation from the rotating dq-reference frame to the stationary abc-reference frame.

The described control method is based on the idea that the stability of a control of a DC-AC or AC-DC (power) converter may be significantly improved by providing a decoupling between a direct current control procedure and a quadrature current control procedure. When being decoupled, a perturbation or a transitional behavior on the quadrature-axis (q-axis) of the rotating dq-reference frame will have no or at least a significantly reduced impact (e.g., unwanted impact) on the direct-axis (d-axis) of the rotating dq-reference frame. The same holds for the impact of a perturbation or a transitional behavior on the d-axis towards the q-axis of the rotating dq-reference frame.

The second control procedure provides a decoupling with modified cross coupling terms on the d-axis and on the q-axis, which are combined with the signals resulting from the first control procedure of the quadrature current error signal and of the direct current error signal, respectively.

The mentioned DC-AC or AC-DC converter may be any power electric device that is capable of inverting a DC-power signal into an AC-power signal or of rectifying an AC-power signal into a DC-power signal based on an appropriate pattern of switching control signals applied to the gates of the semiconductor switches. The semiconductor switches may be, for example, Insulated Gate Bipolar Transistors (IGBT's). Within the converter, the semiconductor switches may be connected with electric valves such that a half-bridge or a full-bridge converter is formed. The electric valves may be, for example, semiconductor diodes.

According to an embodiment, the first control procedure is a proportional-integral control procedure. This may provide the advantage that for carrying out the described control method, usual current and/or voltage controllers may be used.

According to a further embodiment, the second control procedure is an integral control procedure. Also, this may provide the advantage that for carrying out the described control method, usual current and/or voltage controllers may be used.

According to a further embodiment, the transformation from the rotating dq-reference frame to the stationary abc-reference frame is executed further based on a direct voltage feedforward signal resulting from a transformation of three voltages being physically present at three nodes of symmetry within the DC-AC or AC-DC converter from the stationary abc-reference frame to the rotating dq-reference frame, and on a quadrature voltage feedforward signal resulting from a transformation of the three voltages being physically present at the three nodes of symmetry within the DC-AC or AC-DC converter from the stationary abc-reference frame to the rotating dq-reference frame.

Taking into account these two voltage feedforward signals may provide the advantage that on a load side of the converter, harmonic disturbances may be effectively reduced.

According to a further embodiment, the transformation from the rotating dq-reference frame to the stationary abc-reference frame is executed with a modified direct voltage control signal and with a modified quadrature voltage control signal. Thereby, the modified direct voltage control signal is obtained by adding the direct voltage control signal to the direct voltage feedforward signal. Further, the modified quadrature voltage control signal is obtained by adding the quadrature voltage control signal to the quadrature voltage feedforward signal.

Obtaining the described modified direct voltage control signal and the described modified quadrature voltage control signal by a simple summation may provide the advantage that there is only a small effort for generating the signals being used for the described transformation from the rotating dq-reference frame to the stationary abc-reference frame.

Further, by using a simple summation for obtaining the signals (e.g., the modified direct voltage control signal and the modified quadrature voltage control signal) being used for the described transformation from the rotating dq-reference frame to the stationary abc-reference frame, a very quick response with respect to voltage disturbances of the output power signals of the converter may be realized.

According to a further embodiment, the DC-AC or AC-DC converter is a modular multilevel converter including three branches. Each branch includes an upper arm and a lower arm, where each arm includes a serial connection of a plurality of submodules. Each submodule includes a capacitor and two semiconductor switches. Controlling the switching states of the semiconductor switches being assigned to one branch is further executed based on a first reference voltage for the upper arm of the respective branch and a second reference voltage for the lower arm of the respective branch. This may provide the advantage that capacitor voltage variations within each arm of the DC-AC or AC-DC converter may be effectively reduced.

In accordance with the known topology of a modular multilevel converter, the two semiconductor switches of each submodule are connected such that (i) when a first semiconductor switch is On, and the second semiconductor switch is Off, the output voltage Vₒ of this submodule is zero, and (ii) when a first semiconductor switch is Off, and the second semiconductor switch is On, the output voltage Vₒ of this submodule is a nonzero voltage being present over the respective capacitor.

According to a further embodiment, for each branch of the modular multilevel converter, a first reference voltage for the upper arm of the modular multilevel converter is obtained based on (i) a derivative with respect to time of a circulating current circulating through the respective branch, (ii) the actual voltage (V_{dc}) of a DC voltage bridge of the modular multilevel converter, and (iii) one voltage of the three voltages being physically present at three nodes of symmetry within modular multilevel converter, where the one voltage is assigned to the respective branch. Further, for each branch of the modular multilevel converter, a second reference voltage is obtained for the lower arm of the modular multilevel converter based on (i) the derivative with respect to time of the circulating current circulating through the respective branch, (ii) the actual voltage of the DC voltage bridge of the modular multilevel converter, and (iii) one voltage of the three voltages being physically present at three nodes of symmetry within the modular multilevel converter, where the one voltage is assigned to the respective branch. This may provide the advantage that capacitor voltage variations within each arm of the DC-AC or AC-DC converter may be further reduced.

According to a further embodiment, determining the direct current error signal includes comparing, in the rotating dq-reference frame, a calculated active current signal with an active current reference signal. The described comparison may be carried out by a summation unit that determines the difference between the calculated active current signal and the active current reference signal.

The calculated active current signal in the rotating dq-reference frame may be obtained by measuring, in the stationary abc-reference frame, three physically existing currents each being assigned to one phase of a three-phase current within the DC-AC or AC-DC converter, and transforming the three measured currents into the rotating dq-reference frame.

According to a further embodiment, the active current reference signal is determined based on a measured active power signal being indicative for the actual active power being transferred with the DC-AC or AC-DC converter.

Specifically, the active current reference signal may be determined based on an active power error signal that is given by the difference between the measured active power signal and an active power reference signal.

More specifically, the active current reference signal may be determined based on (i) the active power error signal and (ii) an actual voltage error signal that is given by the difference between the actual voltage of the DC voltage bridge of the modular multilevel converter and a given reference signal for the voltage of the DC voltage bridge.

According to a further embodiment, determining the quadrature current error signal includes comparing, in the rotating dq-reference frame, a calculated reactive current signal with a reactive current reference signal. Also, the comparison may be carried out by a summation unit that determines the difference between the calculated reactive current signal and the reactive current reference signal.

Also, the calculated reactive current signal in the rotating dq-reference frame may be obtained by measuring, in the stationary abc-reference frame, the three physically existing currents each being assigned to one phase of the three-phase current within the DC-AC or AC-DC converter, and transforming these three measured currents into the rotating dq-reference frame.

According to a further embodiment, the reactive current reference signal is determined based on a measured reactive power signal being indicative for the actual reactive power being transferred with the DC-AC or AC-DC converter.

Specifically, the reactive current reference signal may be determined based on a reactive power error signal that is given by the difference between the measured reactive power signal and a reactive power reference signal.

According to a further aspect, a controller for controlling the operation of a DC-AC or AC-DC converter including a plurality of semiconductor switches is provided. The provided controller is configured for carrying out the method as described above for controlling the operation of a DC-AC or AC-DC converter including a plurality of semiconductor switches.

Also, the described controller is based on the idea that the stability of an operation of a DC-AC or AC-DC converter may be significantly improved by providing a decoupling between (i) a direct current control procedure and (ii) a quadrature current control procedure. When being effectively decoupled, a perturbation or a transitional behavior on one of the quadrature-axis (q-axis) of the rotating dq-reference frame and the direct-axis (d-axis) of the rotating dq-reference frame will have no or at least a significantly reduced impact (e.g., unwanted impact) on the signal of the other one of the d-axis and the q-axis.

According to a further aspect, a computer program stored on a non-transitory computer-readable storage medium, for controlling the operation of a DC-AC or AC-DC converter including a plurality of semiconductor switches is provided. The computer program, when being executed by a data processor, is adapted for controlling and/or for carrying out the above-described method for controlling the operation of a DC-AC or AC-DC converter.

As used herein, reference to a computer program is intended to be equivalent to a reference to a program element and/or to a computer readable medium including instructions for controlling a computer system to coordinate the performance of the above-described method.

The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which the computer program may be downloaded.

One or more of the present embodiments may be realized using a computer program (e.g., software). However, one or more of the present embodiments may also be realized using one or more specific electronic circuits (e.g., hardware). One or more of the present embodiments may also be realized in a hybrid form (e.g., in a combination of software modules and hardware modules).

Embodiments of the invention have been described with reference to different subject matters. For example, some embodiments have been described with reference to a method, whereas other embodiments have been described with reference to an apparatus. However, a person skilled in the art will gather from the above and the following description that, unless otherwise notified, in addition to any combination of features belonging to one type of subject matter, any combination between features relating to different subject matters (e.g., between features of the method and features of the apparatus) is considered as to be disclosed with this document.

The aspects defined above and further aspects are apparent from the examples to be described hereinafter and are explained with reference to the examples of embodiment.

### BRIEF DESCRIPTION OF THE DRAWINGS

FIG. 1 illustrates the basic structure of a known modular multilevel converter (MMC).

FIG. 2 shows one cell of the MMC illustrated in FIG. 1.

FIG. 3 shows a block diagram of transfer functions of a controller in accordance with an embodiment.

FIG. 4 shows a schematic diagram of a controller in accordance with an embodiment.

FIG. 5 shows an exemplary control block for mitigating capacitor voltage fluctuations in the arms of a MMC.

### DETAILED DESCRIPTION

In different figures, similar or identical elements or features are provided with the same reference signs or with reference signs that are different from the corresponding reference signs only with the first digit. In order to avoid unnecessary repetitions of elements or features that have already been described, these elements or features are not described again at a later position of the description.

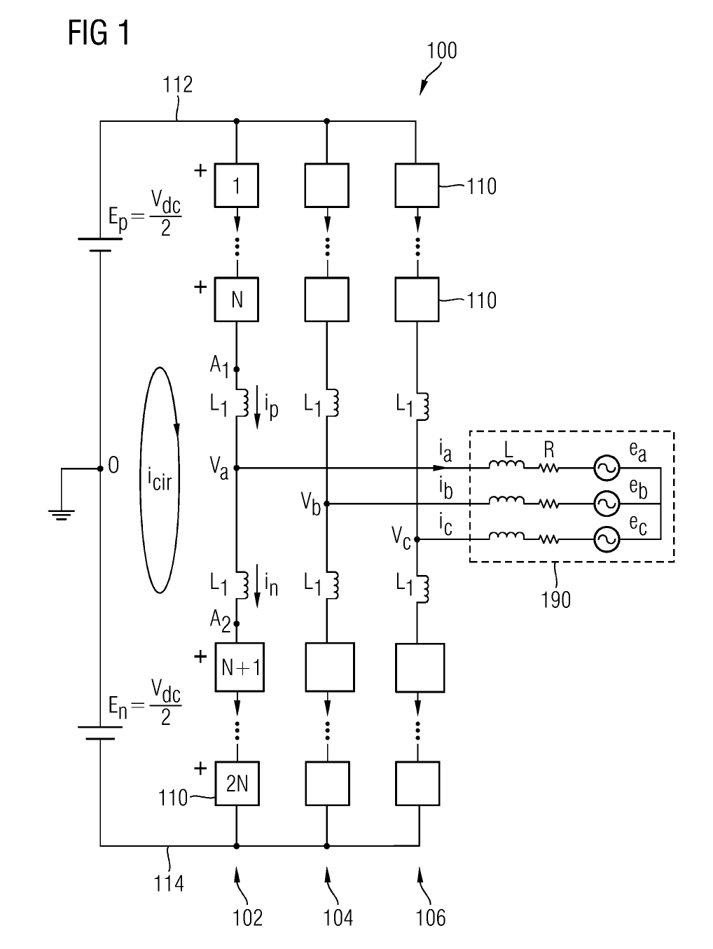

FIG. 1 illustrates the basic structure of a known modular multilevel converter (MMC) 100. According to one embodiment, the MMC 100 is used for converting a DC voltage V_{dc} into a three-phase current having voltages Vₐ, V_{b} and V_{c} and currents iₐ, i_{b} and i_{c} that drive a load 190 (e.g., a three-phase machine 190), respectively. In case the MMC 100 is used as a rectifier, reference numeral 190 would represent a power or supply grid. In FIG. 1, the load 190 (e.g., the three-phase machine 190) is depicted with an equivalent circuit including, for each phase, an inductor L, a resistor R and one of the voltage sources eₐ, e_{b} and e_{c}.

In accordance with the known structure of MMCs, the MMC 100 includes three branches 102, 104 and 106 each being assigned to one phase of the three-phase current. Each branch 102, 104, 106 includes two arms, one upper arm and one lower arm. Each arm includes N cells 110 that are connected in series with an inductor L1. Therefore, the MMC 100 shown in FIG. 1 has a N-level topology and may be called an N-level MMC. The inductor L1 represents in an equivalent circuit the inductance of the respective arm inductor.

In FIG. 1, the current flowing through an upper arm is denominated iₚ. Correspondingly, the current flowing through a lower arm is denominated iₙ. A circulating current between two DC buses 112, 114 or between the three phases is denominated i_{cir}.

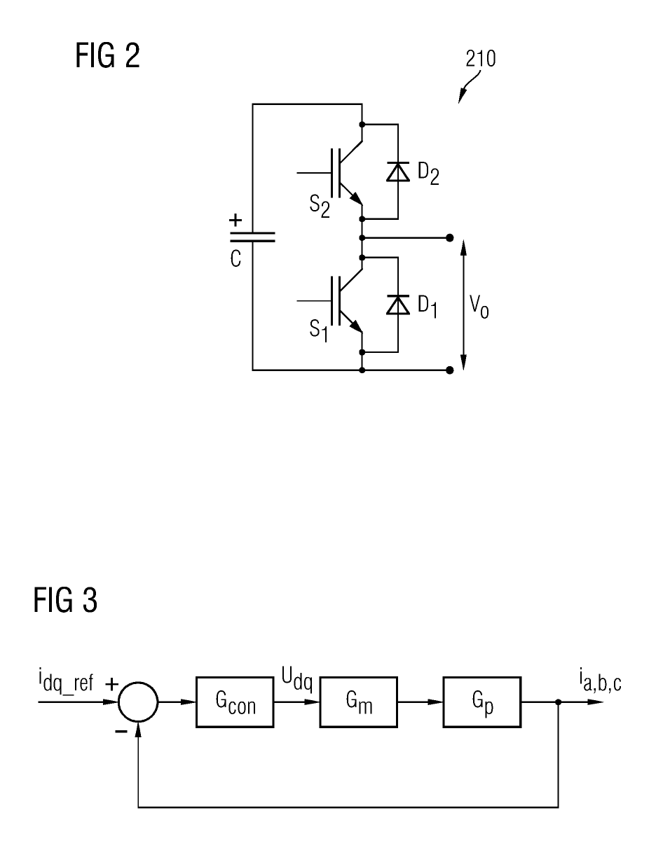

FIG. 2 shows one cell of the MMC 100, which is denominated with reference numeral 210. The cell 210 includes one capacitor C, two semiconductor switches S₁ and S₂ and two diodes D₁ and D₂. According to the embodiment described, the semiconductor switches S₁ and S₂ are Insulated Gate Bipolar Transistors (IGBT's).

In the following, the operating principles of the MMC 100 are described with reference to FIGS. 1 and 2.

From FIG. 1, the Voltage V_{dc} is given by the following equation (1):

$${V}_{dc} = {\sum }_{j = 1}^{2 N} {v}_{j} + {L}_{1} \frac{d }{d t} ( {i}_{p} + {i}_{n} ) \qquad ( 1 )$$

vⱼ is the output voltage of the respective cell, L1 is the inductance of the arm inductor, and iₚ and iₙ are currents in the upper arm and the lower arm, respectively.

When the semiconductor switch S₁ is On, and the semiconductor S₂ is Off, the output voltage Vₒ of the cell 210 will be zero. When the semiconductor switch S₁ is Off, and the semiconductor switch S₂ is On, the output voltage Vₒ of the cell 210 will be unequal to zero. Specifically, the sum of the voltages Vₒ of all cells 210, where S₁ is Off and S₂ is On, will be V_{dc}.

In this respect, without a loss of generality, the analysis has been applied to one phase of the MMC 100 including N cells 110 for each arm.

As discussed above, every branch or phase-leg of the MMC 100 includes two arms where each arm has a number of N cells. In every cell 110 where S₁ is Off and S₂ is On, the respective capacitor C is charged with a part of the voltage V_{dc}. During any moment, half the cells 110 are connected, and half the cells 110 are bypassed. For example, if at a given instant in the upper arm cells 110 from 2 to N are in the On-state, in the lower arm only, one cell 110 should be in On-state. This is provided since the sum of all connected cells 110 in a phase-leg is to be V_{dc}.

The load current iₐ in the A-phase is equal with the sum of the arm currents iₚ and iₙ (Equation (2)), while a circulating current i_{cir} between the DC buses 112, 114 or between the phases is given by Equation (3):

$$\begin{matrix}{i}_{a} = {i}_{p} - {i}_{n} & ( 2 ) \\ {i}_{cir} = \frac{{i}_{p} + {i}_{n}}{2} & ( 3 )\end{matrix}$$

The capacitors C constantly charge/discharge due to the flow of the load current through the capacitors C. Thus, the voltages at points A₁ and A₂ are not exactly equal all the time. The arm inductors L₁ are inserted in the circuit to limit the flow of circulating current i_{cir} due to this voltage difference.

In the following, a scheme for analyzing and controlling the MMC 100 is provided.

The dynamic equations of the ac-side voltages of the MMC 100 in the stationary abc-reference frame are given, based on FIG. 1, as follows:

$${V}_{i} = R \cdot {i}_{i} + L \cdot \frac{d {i}_{i}}{d t} + {e}_{i} \\ where \\ i = a , b or c \qquad ( 4 )$$

The ac system variables are transferred to a dq-reference frame using the Park's transformation. This yields the following nonlinear equation system:

$$\frac{d {i}_{d}}{d t} = - \frac{R}{L} {i}_{d} + \frac{1}{L} ( {V}_{d} - {e}_{d} + ω L \cdot {i}_{q} ) \\ \frac{d {i}_{q}}{d t} = - \frac{R}{L} {i}_{q} + \frac{1}{L} ( {V}_{q} - {e}_{q} + ω L \cdot {i}_{q} ) \qquad ( 5 )$$

Here, i_{d}, i_{q} are the d-axis and q-axis components of the load currents, respectively, and V_{d}, V_{q} are the d-axis and q-axis components of the converter ac output voltages, respectively. Further, e_{d}, e_{q} are the components of the ac voltage source of three-phase supply grid 190 or an electrical machine 190. R and L represent the resistor and inductor of the three-phase ac side.

Equation (5) shows how in the dq-reference frame the dq-voltage equations of the three-phase load connected MMC 100 (see FIG. 1) are dependent due to the two cross-coupling terms ωL.i_{q} and ωL.i_{d}.

From the instantaneous active power (P) and reactive power (Q) theory in the dq-reference frame, the following Equations (6) may be obtained:

P=3/2(V_{d}·i_{d}+V_{q}·i_{q})

Q=3/2(V_{d}·i_{q}−V_{q}·i_{d}) (6)

Under balanced steady-state conditions, the d-axis coincides with the instantaneous load voltage vector. When synchronizing the rotating reference frame and the ac load, the following equation applies:

V_{d}=Vₘ,V_{q}=0 (7)

Vₘ is the peak value of the ac phase voltage of the load.

Thus, the active and reactive power equations will be:

P=3/2V_{d}·i_{d}

Q=3/2V_{d}·i_{q} (8)

From the above equations, the d-axis current and q-axis current components correspond to the real power P and to the reactive power Q, respectively.

The MMC 100 described here is modulated with a PWM unit, and the load current is controlled with the help of a PI controller.

For designing a controller for the MMC 100, a usual method based on an open loop analysis of the control circuit is employed. The corresponding model with transfer functions is shown in FIG. 3, where Gₚ represents the system transfer function, Gₘ represents an equivalent transfer function representing the delay introduced by the PWM modulation circuit, and G_{con} represents the PI controller. The open loop transfer function is given by

Gₒ=G_{con}·Gₘ·Gₚ (9)

After the transformation of Equation (4) in dq-reference frame and after performing Laplace manipulations, considering that the equivalent ac voltage source of the induction motor is steadily at constant value, subtracting eₐ (for the phase-A) from both sides of Equation (4), the system transfer function Gₚ is found. The system transfer function Gₚ according to the embodiment described here is used for the current controller design

$${V}_{a} ( s ) - {e}_{a} ( s ) = {I}_{a} ( s ) \cdot ( R + L \cdot s + j ω L ) \\ \frac{{I}_{a} ( s )}{{V}_{a} ( s ) - {e}_{a} ( s )} = \frac{1 / R}{1 + \frac{L}{R} ( s + j ω )} \qquad ( 10 )$$

Choosing K₁=1/R and T₁=L/R gives

$${G}_{p} ( s ) = \frac{{K}_{l}}{1 + {T}_{l} ( s + j ω )} \qquad ( 11 )$$

The coupling term between the d-axis and the q-axes is depicted by jωT₁.

The equivalent transfer function Gₘ of the PWM block is selected as a first order approximation by taking into account the delays because of the PWM converter and measurement devices and so on.

$${G}_{m} ( s ) = {e}^{- {sT}_{m}} ≅ \frac{1}{1 + {sT}_{m}} \qquad ( 12 )$$

Substituting for Gₚ and Gₘ from (11) and (12) into equation (9), the following equation is obtained:

$${G}_{o} = {G}_{con} \cdot \frac{1}{1 + {sT}_{m}} \cdot \frac{{K}_{l}}{1 + {T}_{l} ( s + j ω )} \qquad ( 13 )$$

For the purpose of eliminating the complex terms, the transfer function of the controller is defined as:

$${G}_{con} ( s ) = \frac{1 + {T}_{l} ( s + j ω )}{{sT}_{i}} \qquad ( 14 )$$

When the dominant time constant of the system T₁ is compensated by the correlation time constant of the controller, the remaining open-loop transfer function becomes:

$${G}_{o} = \frac{{K}_{l}}{{sT}_{i} ( 1 + {sT}_{m} )} \qquad ( 15 )$$

The value of the second parameter of the PI controller, which is the integration time constant Tᵢ, is chosen in order to get a zero-crossing pulsation equal to the half of a breakpoint pulsation of 1/Tₘ.

Controller Equation (14) has a complex transfer function. With extension of the transfer function, the following is provided:

$${G}_{con} ( s ) = ( \frac{1 + {sT}_{l}}{{sT}_{i}} + j \frac{ω {T}_{l}}{{sT}_{i}} ) \\ {u}_{d} + j {u}_{q} = ( \frac{1 + {sT}_{l}}{{sT}_{i}} + j \frac{ω {T}_{l}}{{sT}_{i}} ) ( {Er}_{d} + j {Er}_{q} ) \qquad ( 16 )$$

where Er_{d}=i_{dref}−i_{d} and Er_{q}=i_{qref}−i_{q}.

Following some mathematical effort, the resultant structure of the controller may be described as:

$${u}_{d} + j {u}_{q} = ( \frac{1 + {sT}_{l}}{{sT}_{i}} + j \frac{ω {T}_{l}}{{sT}_{i}} ) ( {Er}_{d} + j {Er}_{q} ) ⇒ \{ \begin{matrix}{u}_{d} = \frac{1 + {sT}_{l}}{{sT}_{i}} \cdot {Er}_{d} - \frac{ω {T}_{l}}{{sT}_{i}} \cdot {Er}_{q} \\ {u}_{q} = \frac{1 + {sT}_{l}}{{sT}_{i}} \cdot {Er}_{q} + \frac{ω {T}_{l}}{{sT}_{i}} \cdot {Er}_{d}\end{matrix} \qquad ( 17 )$$

Equation (17) denotes two first-order systems, where the last two terms of the two first-order systems show the cross coupling parts. u_{d} and u_{q} are new control signals that are generated by two independent PI controllers. One controller processes (i_{dref}−i_{d}) to produce u_{d}, and the other controller takes the same action on (i_{qref}−i_{q}) to produce u_{q}. V_{d} and V_{q} are two feedforward signals added to the control action obtained from Equation (7) for providing a quick response to the ac system voltage disturbances. The parameters of the two PI regulators may be calculated based on classical design methods to achieve good static and dynamic performance of the system.

Equations relating to reference voltages for the PWM unit, the current controller output and the feedforward terms may be deduced as:

v_{d}=u_{d}+V_{d}

v_{q}=u_{q}+V_{q} (18)

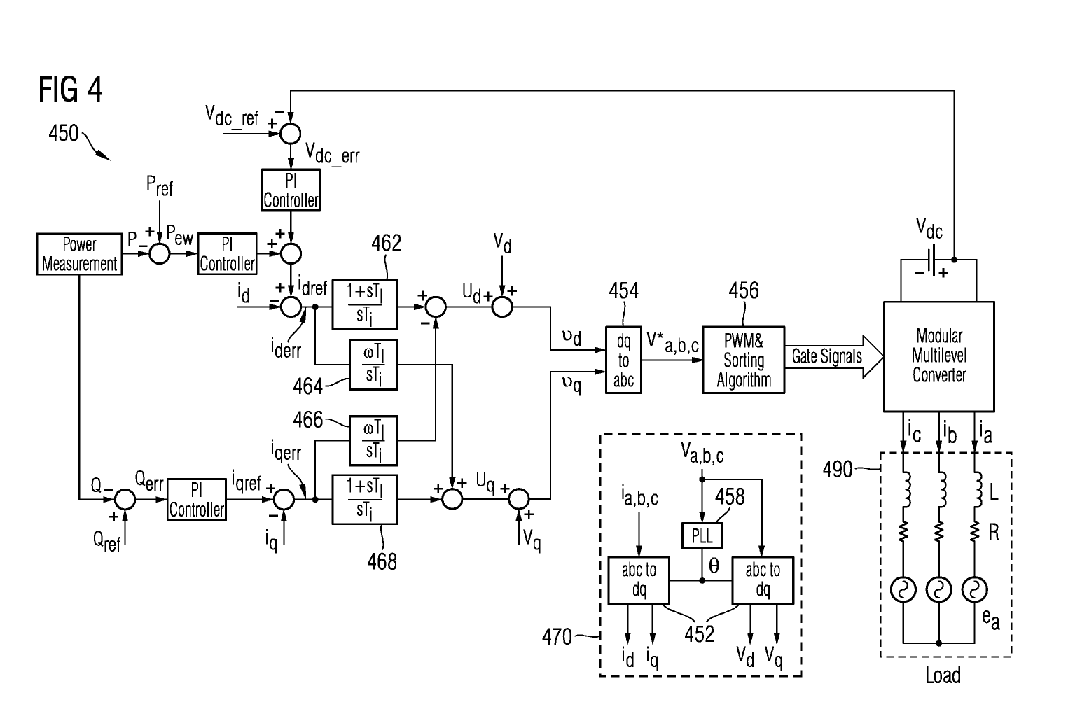

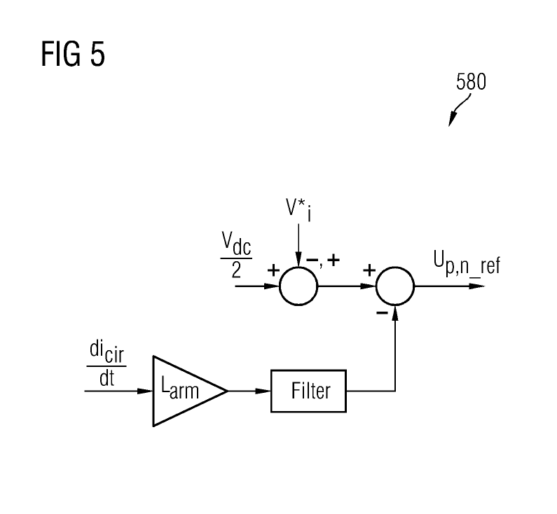

Based on the above equations, the structure of a current controller 450 in accordance with an embodiment is obtained. This structure is shown in FIG. 4.

The active current reference i_{dref} is used to regulate the dc link voltage V_{dc} as well as the active power at the corresponding desired values. As shown in FIG. 4, the active current reference i_{dref} is generated based on a measured active power signal P and a predefined active power reference signal P_{ref}, which are combined to an active power error signal Pₑᵣᵣ. Further, the active current reference i_{dref} is further generated based on the actual DC voltage V_{dc} and a reference signal V_{dc}_{_{—}}_{ref} for the DC voltage V_{dc}, which are combined to a DC voltage error signal V_{dc}_{_{—}}ₑᵣᵣ. As shown in FIG. 4, the reactive current reference i_{qref} is generated based on a measured reactive power signal Q and a predefined reactive power reference signal Q_{ref}, which are combined to a reactive power error signal Qₑᵣᵣ.

As shown in FIG. 4, the obtained reference currents i_{dref} and i_{qref} are fed to a feedback current controller that processes corresponding current error signals i_{derr} and i_{qerr} (e.g., the difference between the calculated active current signal i_{d} and the active current reference signal i_{dref} and the difference between the calculated reactive current signal i_{q} and the reactive current reference signal i_{qref}, respectively) in order to calculate a direct voltage control signal u_{d} and a quadrature voltage control signal u_{d} used for determining modified direct/quadrature control signals v_{d}/v_{q}.

As shown in FIG. 4, the active current reference signal i_{dref} is processed both by a PI controller 462 and by a cross coupling controller 464, which is an integral controller. Correspondingly, the reactive current reference signal i_{qref} is processed both by a PI controller 468 and by a cross coupling controller 466, which is also an integral controller.

The feedback-parameter acquisition is to be modified before being applied in the real circuit in which all parameters are given in the stationary abc-reference frame. Additions to the control designed for the model of a five-level MMC are as follows: a Park's transformation 452, an inverse Park's transformation 454, a PWM generator 456 and a phase lock loop (PLL) 458.

The cross coupling controllers 464 and 466 introduce modified coupling terms that cause an effective decoupling of the d-axis from the q-axis. This decoupling has the positive effect that the stability of an operation of a DC-AC or AC-DC converter may be significantly improved.

According to the embodiment described here, all feedback parameters are measured by using the signal transducers. Originally, these feedback signals are in abc-coordinates. With the proposed control technique, all signals are real-time transferred into the rotating dq-reference frame domain by Park's transformation matrix.

The PLL 458 of a control block 470 is the tool used to obtain the information for system synchronization, which is important for the synchronous-control technique. The inputs of the PLL 458 are the three-phase load voltages Vₐ, V_{b}, V_{c}, and the PLL 458 output is the phase information θ of the voltages Vₐ, V_{b}, V_{c} in the form of cosine and sine functions that are used (i) for abc-dq transformation of the currents iₐ, i_{b} and i_{c} to the calculated active/reactive current signals i_{d} and i_{q} and (ii) for the abc-dq transformation of the voltages Vₐ, V_{b}, V_{c} to a direct feedforward signal V_{d} and a quadrature feedforward signal V_{q}.

The proposed strategy implementation is almost independent from system parameters uncertainties contrary to the existing decoupling approach.

As shown in FIG. 4, three-phase sinusoidal modulation waveforms Vₐ*, v_{b}*, V_{c}* that are the references for the converter output voltages are recovered from modified direct/quadrature control signals v_{d}, v_{q} by the inverse dq-transformation and used as inputs by the PWM block 456 to produce the command signals to the power devices.

In view of Equations (2) and (3) and FIG. 1, the following relations exist (e.g., for the A-phase):

$$\{ \begin{matrix}{E}_{p} - {V}_{a} = {\sum }_{j = 1}^{N} {v}_{j} + {L}_{1} \frac{d }{d t} {i}_{p} \\ {E}_{n} + {V}_{a} = {\sum }_{j = N + 1}^{2 N} {v}_{j} + {L}_{1} \frac{d }{d t} {i}_{n}\end{matrix} ⇒ \{ \begin{matrix}{V}_{a} = \frac{1}{2} ( {\sum }_{j = N + 1}^{2 N} {v}_{j} - {\sum }_{j = 1}^{N} {v}_{j} - {L}_{1} \frac{d }{d t} {i}_{a} ) \\ {E}_{p} + {E}_{n} - {\sum }_{j = 1}^{N} {v}_{j} - {\sum }_{j = N + 1}^{2 N} {v}_{j} = 2 {L}_{1} \frac{d {i}_{cir}}{d t}\end{matrix} \qquad ( 19 \text{-} a ) , ( 19 \text{-} b )$$

The cell capacitor voltages are not constant, and harmonic component appears even in the ideal case because of the flowing ac current. Therefore, arm voltages constitute the dc and ripple components.

A mathematical derivation of the voltage across the arm inductors is given by

$$2 {L}_{1} \frac{d {i}_{cir}}{d t} = - {\sum }_{j = 1}^{2 N} {\tilde{v}}_{j} \qquad ( 20 )$$

\tilde{v}ⱼ denotes the ripple component of cell capacitor voltage in both upper and lower arms.

Consequently, using the technique indicated in FIG. 5, the control circuit loop is responsible for decreasing the voltage fluctuation on floating capacitors in upper and lower arms. Therefore, the reference voltages u_{p,n}_{_{—}}_{ref} of upper and lower arms are expressed as:

$${u}_{p \_ ref} = \frac{{V}_{dc}}{2} - {V}_{i}^{*} - {L}_{1} \frac{d {i}_{cir}}{d t} \\ where \\ i = a , b or c \\ {u}_{n \_ ref} = \frac{{V}_{dc}}{2} + {V}_{i}^{*} - {L}_{1} \frac{d {i}_{cir}}{d t} \qquad ( 21 )$$

The described control procedure for a MMC overcomes drawbacks of existing MMC control procedures by a special proportional-integral control rule that is derived via converter transfer function based on a continuous mathematical model of an MMC, operating as an inverter. By utilizing this technique, the task of current control dynamics, d-axis and q-axis components, become controlled separately of each other while step change occurs in one axis. With the described controller, an MMC is controlled such that the dc link voltage is constant, and the arm voltages across capacitors are balanced with an easy balancing algorithm. A vector control scheme uses the reference frame oriented such that the reference frame is adjusted to the load ac voltage vector, which is divided into two current control loops. An internal loop is used for determining d-axis and q-axis components in response to corresponding reference values by regulating the output voltage references of the converter. An external control loop function is used for calculating the dq current references with respect to a dc link voltage control loop, an active power command and a reactive power reference through PI controllers, respectively. In order to minimize capacitor voltage ripple magnitude, which is an important factor to improve the startup performance of induction motors, a control loop for reducing voltage fluctuation is developed. The proposed structure uses the three phase inner circulating currents in the MMC by adding the voltage drop of the arm inductor to the reference waveforms of the converter obtained from current loop controllers. The proposed structure does not affect the output voltages and currents of the MMC at the ac side.

With the described control procedure, an MMC may be operated in a stable and reliable manner. For example, a high dynamic response may be provided, a disturbance rejection may be provided, and a low harmonic distortion of the output current may be provided. Also, a regulation of the dc-link voltage may be provided, and a bi-directional power flow may be provided.

The term “comprising” does not exclude other elements or steps, and the use of articles “a” or “an” does not exclude a plurality. Also, elements described in association with different embodiments may be combined.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for controlling operation of a DC-AC or AC-DC converter comprising a plurality of semiconductor switches, the method comprising:
determining, in a rotating dq-reference frame, a direct current error signal and a quadrature current error signal;
performing a first control procedure with the direct current error signal and with the quadrature current error signal;
performing a second control procedure with the direct current error signal and with the quadrature current error signal;
obtaining a direct voltage control signal, the obtaining of the direct voltage control signal comprising subtracting a signal resulting from the second control procedure with the quadrature current error signal from a signal resulting from the first control procedure with the direct current error signal;
obtaining a quadrature voltage control signal, the obtaining of the quadrature voltage control signal comprising adding a signal resulting from the second control procedure with the direct current error signal to a signal resulting from first control procedure with the quadrature current error signal;
executing a transformation from the rotating dq-reference frame to a stationary abc-reference frame based on the obtained direct voltage control signal and the obtained quadrature voltage control signal; and
controlling switching states of the plurality of semiconductor switches based on the signals resulting from the executed transformation from the rotating dq-reference frame to the stationary abc-reference frame.

2. The method of claim 1, wherein the first control procedure is a proportional-integral control procedure.

3. The method of claim 1, wherein the second control procedure is an integral control procedure.

4. The method of claim 1, wherein the transformation from the rotating dq-reference frame to the stationary abc-reference frame is based on a direct voltage feedforward signal resulting from a transformation of three voltages being physically present at three nodes of symmetry within the DC-AC or AC-DC converter from the stationary abc-reference frame to the rotating dq-reference frame, and a quadrature voltage feedforward signal resulting from a transformation of the three voltages being physically present at the three nodes of symmetry within the DC-AC or AC-DC converter from the stationary abc-reference frame to the rotating dq-reference frame.

5. The method of claim 4, wherein the method further comprises:
obtaining a modified direct voltage control signal, the obtaining of the modified direct voltage control signal comprising adding the direct voltage control signal to the direct voltage feedforward signal; and
obtaining a modified quadrature voltage control signal, the obtaining of the modified quadrature voltage control signal comprising adding the quadrature voltage control signal to the quadrature voltage feedforward signal, and
wherein the transformation from the rotating dq-reference frame to the stationary abc-reference frame is executed with the modified direct voltage control signal and with the modified quadrature voltage control signal.

6. The method of claim 1, wherein the DC-AC or AC-DC converter is a modular multilevel converter comprising three branches, each branch of the three branches comprising an upper arm and a lower arm, each arm of the upper arm and the lower arm comprising a serial connection of a plurality of submodules, each submodule of the plurality of submodules comprising a capacitor and two semiconductor switches, and
wherein controlling the switching states of the plurality of semiconductor switches being assigned to one branch of the three branches is further executed based on a first reference voltage for the upper arm of the respective branch and a second reference voltage for the lower arm of the respective branch.

7. The method of claim 6, further comprising:
obtaining, for each branch of the three branches of the modular multilevel converter, a first reference voltage for the upper arm of the modular multilevel converter based on a derivative with respect to time of a circulating current circulating through the respective branch, an actual voltage of a DC voltage bridge of the modular multilevel converter, and one voltage of the three voltages being physically present at three nodes of symmetry within the modular multilevel converter, wherein the one voltage is assigned to the respective branch; and
obtaining, for each branch of the three branches of the modular multilevel converter, a second reference voltage for the lower arm of the modular multilevel converter based on a derivative with respect to time of the circulating current circulating through the respective branch, the actual voltage of the DC voltage bridge of the modular multilevel converter, and the one voltage of the three voltages being physically present at three nodes of symmetry within the modular multilevel converter, wherein the one voltage is assigned to the respective branch.

8. The method of claim 1, wherein determining the direct current error signal comprises comparing, in the rotating dq-reference frame, a calculated active current signal with an active current reference signal.

9. The method of claim 8, wherein the active current reference signal is determined based on a measured active power signal being indicative for an actual active power being transferred with the DC-AC or AC-DC converter.

10. The method of claim 1, wherein determining the quadrature current error signal comprises comparing, in the rotating dq-reference frame, a calculated reactive current signal with a reactive current reference signal.

11. The method of claim 10, wherein the reactive current reference signal is determined based on a measured reactive power signal being indicative for an actual reactive power being transferred with the DC-AC or AC-DC converter.

12. A controller for controlling operation of a DC-AC or AC-DC converter comprising a plurality of semiconductor switches, wherein the controller is configured to:
determine, in a rotating dq-reference frame, a direct current error signal and a quadrature current error signal;
perform a first control procedure with the direct current error signal and with the quadrature current error signal;
perform a second control procedure with the direct current error signal and with the quadrature current error signal;
obtain a direct voltage control signal, the obtaining of the direct voltage control signal comprising subtracting a signal resulting from the second control procedure of the quadrature current error signal from a signal resulting from the first control procedure of the direct current error signal;
obtain a quadrature voltage control signal, the obtaining of the quadrature voltage control signal comprising adding a signal resulting from the second control procedure of the direct current error signal to a signal resulting from the first control procedure of the quadrature current error signal;
execute a transformation from the rotating dq-reference frame to a stationary abc-reference frame based on the obtained direct voltage control signal and the obtained quadrature voltage control signal; and
control switching states of the plurality of semiconductor switches based on the signals resulting from the executed transformation from the rotating dq-reference frame to the stationary abc-reference frame.

13. In a non-transitory computer-readable storage medium having stored therein data representing instructions executable by a programmed processor for controlling operation of a DC-AC or AC-DC converter comprising a plurality of semiconductor switches, the instructions comprising:
determining, in a rotating dq-reference frame, a direct current error signal and a quadrature current error signal;
performing a first control procedure with the direct current error signal and with the quadrature current error signal;
performing a second control procedure with the direct current error signal and with the quadrature current error signal;
obtaining a direct voltage control signal, the obtaining of the direct voltage control signal comprising subtracting a signal resulting from the second control procedure of the quadrature current error signal from a signal resulting from the first control procedure of the direct current error signal;
obtaining a quadrature voltage control signal, the obtaining of the quadrature voltage control signal comprising adding a signal resulting from the second control procedure of the direct current error signal to a signal resulting from the first control procedure of the quadrature current error signal;
executing a transformation from the rotating dq-reference frame to a stationary abc-reference frame based on the obtained direct voltage control signal and the obtained quadrature voltage control signal; and
controlling switching states of the plurality of semiconductor switches based on the signals resulting from the executed transformation from the rotating dq-reference frame to the stationary abc-reference frame.

14. The non-transitory computer-readable storage medium of claim 13, wherein the first control procedure is a proportional-integral control procedure.

15. The non-transitory computer-readable storage medium of claim 13, wherein the second control procedure is an integral control procedure.

16. The non-transitory computer-readable storage medium of claim 13, wherein the transformation from the rotating dq-reference frame to the stationary abc-reference frame is based on a direct voltage feedforward signal resulting from a transformation of three voltages being physically present at three nodes of symmetry within the DC-AC or AC-DC converter from the stationary abc-reference frame to the rotating dq-reference frame, and a quadrature voltage feedforward signal resulting from a transformation of the three voltages being physically present at the three nodes of symmetry within the DC-AC or AC-DC converter from the stationary abc-reference frame to the rotating dq-reference frame.

17. The non-transitory computer-readable storage medium of claim 16, wherein the instructions further comprise:
obtaining a modified direct voltage control signal, the obtaining of the modified direct voltage control signal comprising adding the direct voltage control signal to the direct voltage feedforward signal; and
obtaining a modified quadrature voltage control signal, the obtaining of the modified quadrature voltage control signal comprising adding the quadrature voltage control signal to the quadrature voltage feedforward signal, and
wherein the transformation from the rotating dq-reference frame to the stationary abc-reference frame is executed with the modified direct voltage control signal and with the modified quadrature voltage control signal.

18. The non-transitory computer-readable storage medium of claim 13, wherein the DC-AC or AC-DC converter is a modular multilevel converter comprising three branches, each branch of the three branches comprising an upper arm and a lower arm, each arm of the upper arm and the lower arm comprising a serial connection of a plurality of submodules, each submodule of the plurality of submodules comprising a capacitor and two semiconductor switches, and
wherein controlling the switching states of the plurality of semiconductor switches being assigned to one branch of the three branches is further executed based on a first reference voltage for the upper arm of the respective branch and a second reference voltage for the lower arm of the respective branch.

19. The non-transitory computer-readable storage medium of claim 18, wherein the instructions further comprise:
obtaining, for each branch of the three branches of the modular multilevel converter, a first reference voltage for the upper arm of the modular multilevel converter based on a derivative with respect to time of a circulating current circulating through the respective branch, an actual voltage of a DC voltage bridge of the modular multilevel converter, and one voltage of the three voltages being physically present at three nodes of symmetry within the modular multilevel converter, wherein the one voltage is assigned to the respective branch; and
obtaining, for each branch of the three branches of the modular multilevel converter, a second reference voltage for the lower arm of the modular multilevel converter based on a derivative with respect to time of the circulating current circulating through the respective branch, the actual voltage of the DC voltage bridge of the modular multilevel converter, and the one voltage of the three voltages being physically present at three nodes of symmetry within the modular multilevel converter, wherein the one voltage is assigned to the respective branch.

20. The non-transitory computer-readable storage medium of claim 13, wherein determining the direct current error signal comprises comparing, in the rotating dq-reference frame, a calculated active current signal with an active current reference signal.
